(19) United States
(12) Patent Application Publication
(10) Pub. No.: US 2021/0226838 A1
(43) Pub. Date: Jul. 22, 2021

(54) METHOD AND NETWORK NODES FOR MANAGING ACTIONS OCCURRING IN A NETWORK SLICE OF A COMMUNICATION NETWORK

(71) Applicant: Telefonaktiebolaget LM Ericsson (publ), Stockholm (SE)

(72) Inventors: Charles HEGARTY, Bromma (SE); Herbie FRANCIS, Stockholm (SE); Murali Krishna PILLA, Stockholm (SE)

(73) Assignee: Telefonaktiebolaget LM Ericsson (publ), Stockholm (SE)

(21) Appl. No.: 17/055,132

(22) PCT Filed: Jun. 8, 2018
(86) PCT No.: PCT/SE2018/050595

§ 371 Date: Nov. 13, 2020

(51) Int. Cl. H04L 12/24; H04W 24/04; H04W 48/18; H04M 15/00; H04L 29/06

(52) U.S. Cl. CPC H04L 41/0213; H04L 41/0893; H04W 24/04; H04L 65/1069; H04M 15/66; H04L 65/1016; H04W 48/18

(57) ABSTRACT

A method performed by an IP Multimedia Core Network Subsystem (IMS) node, for enabling management of events occurring in a network slice of a communication network that comprises partitioned sets of functionalities wherein each set of functionalities belongs to a dedicated network slice, and wherein a set of functionalities is separated from other sets of functionalities. The IMS node obtains, from a core network node responsible for policy control, an indication of a first action relating to a session established in the network slice, wherein said first indication comprises a first network slice identifier. The IMS node sends, to a managing node, a message indicating a second action to be performed in the managing node in response to the first action relating to the session established in the network slice, wherein the message comprises a second network slice identifier identifying the first network slice in which the first action occurred.

### TECHNICAL FIELD

Embodiments herein relate to a method and network nodes for managing actions occurring in a network slice of a communication network. In particular the embodiments herein relate to an IMS node, a managing node and a core network node and corresponding methods. Embodiments also relate to a computer program product and a computer-readable storage medium for performing the method.

### BACKGROUND

The wireless communication industry is at the verge of a unique business crossroads. The growing gap between capacity and demand is an urgent call for new approaches and alternative network technologies to enable mobile operators to achieve more with less. Today, mobile broadband data is growing at an annual rate of 40-50 percent per year in the U.S. and other regions globally. Mobile service providers address these rapidly expanding traffic volumes through deployment of additional network functions, which will be a significant capital expenditure (CAPEX) challenge. The nature of the mobile broadband data traffic is also evolving with new services including new video applications, connected cars and the Internet of Things (IoT). This rapid capacity growth and increasing traffic diversity in LTE networks stresses the assumptions of existing network architectures and operational paradigms.

As expected by leading operators and vendors in Next Generation Mobile Networks (NGMN) association, diverse applications or services are expected to be provided by 5^{th}-Generation (5G) networks. 5G will support countless emerging use cases with a high variety of applications and variability of their performance attributes: from delay-sensitive video applications to ultra-low latency, from high speed entertainment applications in a vehicle to mobility on demand for connected objects, and from best effort applications to reliable and ultra-reliable ones such as health and safety. Furthermore, use cases will be delivered across a wide range of devices, e.g., smartphones, wearables, MTCs, and across a fully heterogeneous environment.

Network Functions Virtualization (NFV) provides a new path that can increase the flexibility required by mobile service providers and network operators to adapt and accommodate this dynamic market environment. NFV is a new operational approach applying well-known virtualization technologies to create a physical Commercial Off-the-Shelf (COTS) distributed platform for the delivery of end-to-end services in the context of the demanding environment of telecom network infrastructure and applications.

Because the Evolved Packet Core (EPC) is critical to the realization and management of all LTE traffic, it is important to consider use cases related to virtualization of the EPC elements. An EPC element is a functional element comprised in the EPC, such as e.g. a Serving Gateway (Serving GW), a Packet Data Network Gateway (PDN GW), a Mobility Management Entity (MME) and a Home Subscriber Service (HSS). Each individual EPC element also has specific considerations that determine whether to deploy with NFV. Deploy when used herein means that the element is provided as a virtualized network element. Multiple virtualized network functions (VNF) may be deployed and managed on a Network Functions Virtualization Infrastructure (NFVI) but must cater to performance scalability in both signaling/control plane and user plane, each potentially demanding different levels of NFVI resources.

vEPC elements may benefit from more agile deployment and scalability. However, virtual resource monitoring and orchestration, along with service awareness, are essential for implementing flexibility effectively. Due to the nature of telecom networks, service Level Agreements (SLA) will be a key issue for a virtualized mobile core network. Because virtualization usually leads to a performance trade-off, equipment vendors must optimize data-plane processing to satisfy carrier-grade bandwidth and latency requirements and sufficient control-plane performance for SLAs needed to ensure availability of regulatory services, such as emergency calls.

VNF is a virtualized network function which may serve as a VNF Software for providing virtual network capabilities. A VNF may be decomposed and instantiated in roles such as virtualized Mobility Management Entity (vMME), Virtualized PCRF (vPCRF), Virtualized SGW (vSGW) or Virtualized PDN-GW (vPDN-GW).

NFV is seen as an enabler for network slicing and network sharing that is described herein.

Network slicing is about creating logically separated partitions of the network, which may also be referred to as slices or network slices, addressing different business purposes. These network slices are logically separated to a degree that they can be regarded and managed as networks of their own.

Network slicing applies to both LTE Evolution and New 5G RAT, which herein is also referred to as New Radio (NR). The key driver for introducing network slicing is business expansion, i.e. improving the operator's ability to serve other industries, by offering connectivity services with different network characteristics, such as e.g. performance, security, robustness, and/or complexity.

The current main working assumption is that there will be one shared Radio Access Network (RAN) infrastructure that will connect to several EPC instances, where one EPC instance relates to one network slice. As the EPC functions are being virtualized, it is assumed that an operator will instantiate a new CN when a new slice should be supported.

Network sharing, which is described in 3GPP TR 22.951 and 3GPP TS 23.251, is a way for operators to share the heavy deployment costs for mobile networks, especially in the roll-out phase. In the current mobile telephony marketplace, functionality that enables various forms of network sharing is becoming more and more important.

A network sharing architecture allows different core network operators to connect to a shared RAN. The operators do not only share radio network elements, but may also share radio resources themselves. In addition to this shared radio access network, the operators may or may not have additional dedicated radio access networks.

When looking at the wide range of applications and use cases that are addressed with a 5G network, it is quite obvious these cannot effectively be addressed with a traditional approach of having a purpose built network for each application. This will lead to high cost for networks and devices as well as inefficient use of valuable frequency resources. Obviously, different use cases put different requirements to future networks. Examples of such requirements may include acceptable interruption time, reliability and availability, acceptable latency, data rate, as well as cost per user. It would be quite difficult or cost-wise impossible to deploy a common network service to fulfill such extremely diverse requirements. In the situation, network slicing was proposed as a concept to fulfill rich requirements from various 5G use cases. Meanwhile, the network slicing concept is getting widely recognized in NGMN. A network slice supports the communication service of a particular connection type with a specific way of handling control plane and user plane for the service. A 5G slice may be composed by a collection of 5G network functions and possibly specific Radio Access Technology (RAT) with specific settings that are combined together for the specific use case or business model. It should be noted that not all slices contain the same network functions. A specific network service may be instantiated according to on demand requirements for third party users/operators and the business policy between the network service providers and network the service consumers. Thus, an operator may have one physical network infrastructure and one pool of frequency bands, which may support many separate virtualized networks, also called network slices. Each network slice may have unique characteristics for meeting the specific requirements of the use case/s it serves.

A key function of 5G Core network is to allow for flexibility in network service creation, making use of different network functions suitable for the offered service in a specific network slice, e.g. Evolved Mobile Broadband (MBB), Massive Machine Type Communication (MTC), Critical MTC, Enterprise, etc.

In addition to Service optimized networks there are more drivers for Network slicing, such as;
Business expansion by low initial investment: Given the physical infrastructure it is much easier to instantiate another Packet Core instance for the business expansion than to set up a new parallel infrastructure or even integrated nodes
Low risk by no/limited impact on legacy: As the new instance is logically separated from the other network slices, the network slices can also provide resource isolation between each other. Thus introduction of a new isolated network slice will not impact the existing operator services and therefore only provide low risk
Short Time To Market (TTM): The operators are concerned about the time it takes to set up the network for a new service. Slicing of the network for different services/operator use cases provides a separation of concern that can result in a faster setup of a network slice for a certain service as it is separately managed and with limited impact on other network slices
Optimized use of resources: Today the network is supporting many different services but with new use cases and more diverging requirements there is a need for optimize the network for the specific type use case. Network slicing allows to match services to optimized network instances, and it also allows for a more optimized use of those specific resources
Allows for individual network statistics: With service specific network slices and possibly even on the level of individual enterprises, there is a possibility of collecting network statistics specific for a limited and well defined group of users of the network slice. This is not the key driver for slicing but rather a benefit that may be a useful tool

Slicing may also be used to isolate different services in an operator's network. Future networks are expected to support new use cases going beyond the basic support for voice services and mobile broadband currently supported by existing cellular network, e.g. 2G/3G/4G. Some example use cases include:
Evolution of MBB
   Evolved communication services
   Cloud services
   Extended mobility and coverage
Mission critical Machine Type Communication
   Intelligent traffic systems
   Smart grid
   Industrial applications
Massive Machine Type Communication
   Sensors/actuators
   Capillary networks
Media
   Efficient on-demand media delivery
   Media awareness
   Efficient support for broadcast services

These use cases are expected to have different performance requirements, e.g. bit-rates, latencies, as well as other network requirements, e.g. mobility, availability, security etc., affecting the network architecture and protocols.

Supporting these use cases could also mean that new players and business relations are needed compared to existing cellular networks. For instance it is expected that future network should address the needs of
Enterprise services
Government services, e.g. national and/or public safety
Verticals industries, e.g. automation, transportation
Residential users

Although solutions for handling network slices in a packet core network are known, in some scenarios the known solutions are not sufficiently flexible.

### SUMMARY

There are no mechanisms in the 3GPP IMS network to determine which network slice a user is consuming services from or which network slice a specific Network Function (NF) instance and/or managed instance is deployed in, which may be required by functionality such as e.g. licensing, charging, and Operation and Maintenance (O&M).

Using the charging function to exemplify the problem, there are currently no mechanisms existing to determine which slice a subscriber is allocated and/or attached to from a resource usage perspective. An operator, such as e.g. a charging system of the operator, cannot determine from which network slice, a charging event was generated, for a subscriber's resource usage belonging to the same bearer, session and/or service. The charging event may e.g. be generated, which may also be referred to as being triggered, by a Charging Triggering Function (CTF). There currently does not exist a correlation mechanism in 5G Core—IP Multimedia Network Subsystem (5GC-IMS) for associating this information.

Hence, operators are limited in their ability to provide different charging plans per network slice and to determine cost related end-to-end (E2E) multivendor resource usage per network slice and per service and are thus limited in their flexibility.

An object of the embodiments herein is thus to provide a method for allowing slice specific service and application management for network instances in the communications network.

According to an aspect of embodiments herein, the object is achieved by a method performed by an IMS node, for managing actions occurring in a network slice of a communication network. The communication network comprises partitioned sets of functionalities wherein each set of functionalities belongs to a dedicated network slice, and wherein a set of functionalities is separated from other sets of functionalities out of a total set of functionalities in the communication network. The IMS node obtains, from a core network node responsible for policy control, an indication of a first action relating to a session established in the network slice. The first indication comprises a first network slice identifier identifying the network slice. The IMS node further sends, to a managing node, a message indicating a second action to be performed in the managing node in response to the first action relating to the session established in the network slice, and wherein the message comprises a second network slice identifier identifying the first network slice in which the first action occurred.

According to a second aspect of embodiments herein, the object is achieved by a method performed by a managing node, for managing actions occurring in a network slice of a communication network. The communication network comprises partitioned sets of functionalities wherein each set of functionalities belongs to a dedicated network slice, and wherein a set of functionalities is separated from other sets of functionalities out of a total set of functionalities in the communication network. The managing node receives, from an IMS node, a message indicating a second action to be performed in response to a first action relating to the session established in the network slice. The message comprises a second network slice identifier identifying the first network slice in which the first action occurred. The managing node performs the second action in the received message, wherein the second action is performed based on an identity of the first network slice in which the first action occurred.

According to a third aspect of embodiments herein, the object is achieved by a method performed by a core network node responsible for policy control, for managing actions occurring in a network slice of a communication network. The communication network comprises partitioned sets of functionalities wherein each set of functionalities belongs to a network slice, and wherein a set of functionalities is separated from other sets of functionalities out of a total set of functionalities in the communication network. The core network node obtains information regarding a network slice in which a first action relating to a session established in the network slice occurs. The core network node further provides, to an IMS node, an indication of the first action relating to the session established in the network slice. Wherein said indication comprises a first network slice identifier identifying the network slice.

According to a fourth aspect of embodiments herein, the object is achieved by an IMS node for managing actions occurring in a network slice of a communication network. The communication network comprises partitioned sets of functionalities wherein each set of functionalities belongs to a dedicated network slice, and wherein a set of functionalities is separated from other sets of functionalities out of a total set of functionalities in the communication network. The IMS node is configured to obtain, from a core network node responsible for policy control, an indication of a first action relating to a session established in the network slice. The first indication comprises a first network slice identifier identifying the network slice. The IMS node is configured to send, to a managing node, a message indicating a second action to be performed in the managing node in response to the first action relating to the session established in the network slice. The message comprises a second network slice identifier identifying the first network slice in which the first action occurred.

According to a fifth aspect of embodiments herein, the object is achieved by a managing node, for managing actions occurring in a network slice of a communication network. The communication network comprises partitioned sets of functionalities wherein each set of functionalities belongs to a dedicated network slice, and wherein a set of functionalities is separated from other sets of functionalities out of a total set of functionalities in the communication network. The managing node is configured to receive, from an IMS node, a message indicating a second action to be performed in response to a first action relating to the session established in the network slice. The message comprises a second network slice identifier identifying the first network slice in which the first action occurred. The managing node is configured to perform the second action in the received message, wherein the second action is performed based on an identity of the first network slice in which the first action occurred.

According to a sixth aspect of embodiments herein, the object is achieved by a core network node responsible for policy control, for managing actions occurring in a network slice of a communication network. The communication network comprises partitioned sets of functionalities wherein each set of functionalities belongs to a network slice, and wherein a set of functionalities is separated from other sets of functionalities out of a total set of functionalities in the communication network. The core network node is configured to obtain information regarding a network slice in which a first action relating to a session established in the network slice occurs. The core network node is configured to provide, to an IMS node, an indication of the first action relating to the session established in the network slice, wherein said indication comprises a first network slice identifier identifying the network slice.

By the IMS node obtaining the indication of a first action relating to a session established in the network slice and sending, to the managing node, a message indicating a second action to be performed in the managing node in response to the first action relating to the session established in the network slice, wherein the message comprises a second network slice identifier identifying the first network slice in which the first action occurred, the embodiments herein have the advantage that they allow the IMS to identify which slice a specific functionality or action is performed in. This enables a granular end-to-end correlation per service, per resource and per network slice. In the case of e.g. a charging service, the correlation between domains within the same slice, such as e.g. between IMS and 5GC may be enhanced. The embodiments herein further enable an operator to differentiate and provide charging plans per network slice. They further enable operators to determine cost related end-to-end multivendor resource usage per network slice and per service. Since the IMS is notified about the slice ID the embodiments herein also enable IMS routing decisions to different 5GC network slices.

The embodiments herein further have the advantage that they allow a continuity correlation where users and services may move or be “handed-over” to parallel slices.

Furthermore, a managing node, such as a BSS, can correlate license cost across slices & domains, since a licensing functionality within each domain and slice reports the same identity to the managing node.

A network entity (NE) of a specific slice may send a report to an Operations and Management (O&M) node using its received network slice ID. The managing node, such as e.g. an OSS can thus correctly identify and produce results per slice.

### BRIEF DESCRIPTION OF THE DRAWINGS

FIG. 1 is a schematic block diagram illustrating embodiments of a wireless communications network;

FIG. 2 is a schematic block diagram illustrating embodiments of an IMS core network;

FIG. 3 is a flowchart illustrating an overview of a signaling flow according to the embodiments disclosed herein;

FIG. 4 is a flowchart illustrating a detailed view of the signaling flow according to the embodiments disclosed herein;

FIG. 5 is a flowchart illustrating a method performed by an IMS node;

FIG. 6 is a flowchart illustrating a method performed by a managing node;

FIG. 7 is a flowchart illustrating a method performed by a core network node;

FIG. 8 is a schematic block diagram illustrating some first embodiments of the IMS node;

FIG. 9 is a schematic block diagram illustrating some second embodiments of the IMS node;

FIG. 10 is a schematic block diagram illustrating some first embodiments of the managing node;

FIG. 11 is a schematic block diagram illustrating some second embodiments of the managing node;

FIG. 12 is a schematic block diagram illustrating some first embodiments of the core network node;

FIG. 13 is a schematic block diagram illustrating some second embodiments of the core network node.

### DETAILED DESCRIPTION

As part of developing embodiments herein the inventors have realized a problem that first will be discussed.

As specified in 3rd Generation Partnership Program (3GPP) TS 23.501 “System Architecture for the 5G System; Stage 2” a network slice is a logical network that provides specific network capabilities and network characteristics. A network slice instance is defined as “a set of Network Function instances and the required resources, such as (e.g. computing, storage and networking resources) which form a deployed Network Slice”. A number of Network Slice related Identifier(s) have been defined for the packet switched domain. These are Network Slice Instance Identifier (NSIID), Network Slice Selection Assistance Information (NSSAI) & Single Network Slice Selection Assistance Information (S-NSSAI). The NSSAI is a collection of S-NSSAls and may comprise up to 8 S-NSSAIs.

As outlined in 3GPP TS 32.240 “Charging management; Charging architecture and principles”, charging data correlation combines charging events generated by Charging Triggering Functions (CTFs) while they are belonging to the same bearer, session and/or service resource usage. The correlation provides an association of charging information for the mobile subscriber's resource usage.

The correlation is currently based on specific access network charging identifier:

For the Packet Switched domain a Packet Gateway (P-GW) address and an Evolved Packet Core (EPC) Charging ID is used. For the IMS an IMS Charging Identifier (ICID) is be used.

An IMS charging correlation information may be encoded (as specified in 3GPP TS 32.260) in a Session Initiation Protocol (SIP) P-Charging-Vector (PCV) header. The P-Charging-Vector header contains the following parameters: The ICID, an access network charging identifier and an Inter Operator Identification (IOI).

The IMS, such as e.g. a Proxy Call Session Control Function (P-CSCF) node may receive the access network charging identifier generated by the EPC, such as e.g. an Enhanced Cell Identity (ECID) from a Policy and Charging Rules Function (PCRF) node via an Rx Interface (see e.g. 3GPP TS 29.214 chapter 4.4.6.5-Access Network Charging Information Notification; “the Re-Auth-Request (RAR) shall include a Specific-Action AVP set to the value “CHARGING CORRELATION EXCHANGE” and shall include the assigned Access Network-Charging-Identifier(s)”).

In 5G core (5GC) and related IMS deployments, operators may deploy multiple network slices to meet a variety of business needs, such as e.g. specific network characteristics required by a service provided to a business customer or a need to isolate specific traffic and/or data for security reasons or internal organization reasons, such as e.g. fixed/mobile organization in the operator domain, etc. A subscriber depending on their subscribed service may potentially be allocated to a plurality of network slices; as specified in 3GPP TS 23.501 an NSSAI may contain up to 8 S-NSSAI.

Currently there are no mechanisms in the 3GPP IMS network to determine which slice a user is consuming services from or which slice a specific Network function (NF) instance and/or managed instance is deployed in, which may be required by functionality such as e.g. licensing, charging, and Operation and Maintenance (O&M).

Using the charging function to exemplify the problem there are currently no mechanisms existing to determine which slice a subscriber is allocated and/or attached to from a resource usage perspective. An operator, such as e.g. a charging system of the operator, cannot determine from which network slice charging events, such as e.g. from CTFs, were generated for a subscriber's resource usage belonging to the same bearer, session and/or service. There currently does not exist a correlation mechanism in 5GC-IMS for associating this information.

Hence, operators are limited in their ability to provide different charging plans per network slice and to determine cost related end-to-end (E2E) multivendor resource usage per network slice and per service.

Similar problems exist in the routing area whereby IMS will be expected to cater for session establishment requests from different 5GC slices and will be expected to route terminating traffic correctly (terminating traffic to be directed to the slice that the UE has been allocated to). Currently no mechanism exists to enable this for the same APN.

Furthermore problems may arise in the area of O&M and licensing where Base Station (BS) systems may require information from specific slices on which the subscriber currently is consuming services or on which slice a specific network element (NE) is reporting from. The information may be used in policy decisions and analytics.

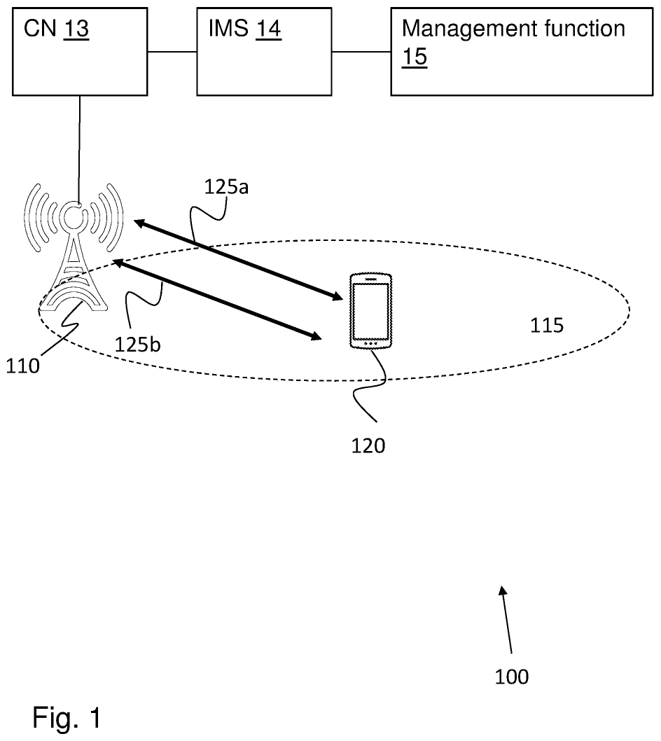

FIG. 1 is a block diagram illustrating an example wireless communication network 100, wherein embodiments herein may be implemented. One or more User Equipment (UE) 120 operate in the wireless communication network 100, such as e.g. mobile phones, smart phones, laptop computers, tablet computers, Machine-Type

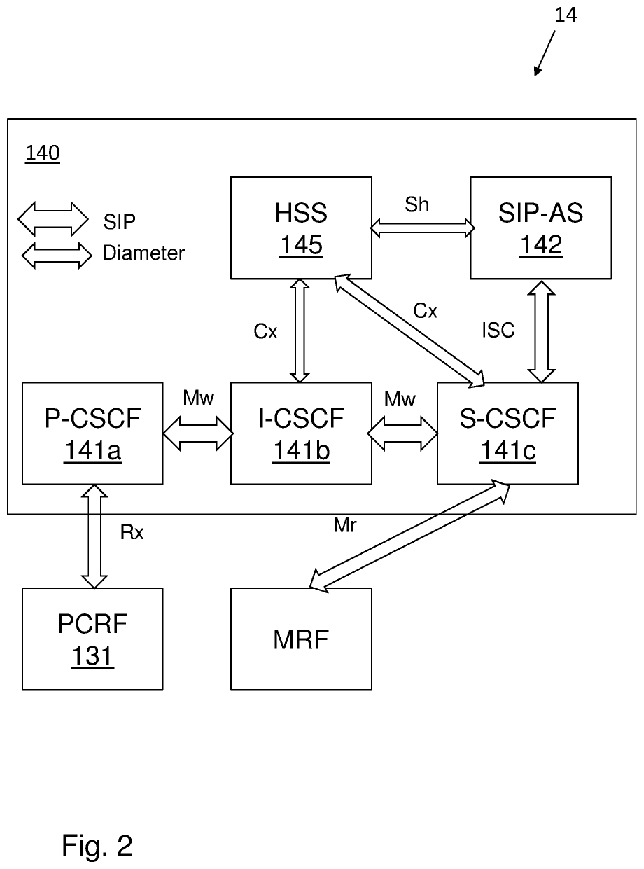

Communication (MTC) devices, mobile stations, stations (STA), or any other devices that can provide wireless communication and thus may also be referred to as a wireless device. The UE 120 may communicate via the wireless communication network 100, such as a Local Area Network (LAN), such as e.g. a Wi-Fi network, or a RAN to one or more core networks (CN) 13. The wireless communication network 100 further comprises a network node 110, such as e.g. a radio access node e.g., a Wi-Fi access point or a radio base station (RBS), which in some networks may also be denoted, for example, a NodeB, eNodeB (eNB), or gNodeB (gNB) as denoted in New Radio (NR). NR may also be referred to as 5G. The network node 110 serves a coverage area 115, which may also be referred to as e.g. a cell, a beam or a beam group. The core network 13 may comprise one or more core network nodes 130, such as e.g. a Serving Gateway (Serving GW), a Packet Data Network Gateway (PDN GW), a Mobility Management Entity (MME) and/or a Home Subscriber Server (HSS). The core network 13 may further be connected to an IMS core network 14, comprising one or more IMS nodes 140, which is shown in further detail in FIG. 2. The IMS core network 14 may be connected to a management function 15, such as e.g. an Operations Support System/Business Support System (OSS/BSS), which supports a range of telecommunication services in the telecommunication network 100. The management function 15 may comprise one or more managing nodes 150 (not shown in FIG. 1).

In general, UEs such as the UE 120 that are within coverage of the network node 110, such as e.g., within the cell 115 served by network node 110, communicate with the network node 110 by transmitting and receiving wireless signals over a first and a second network slice 125a, 125b, which may also be referred to as a link. For example, the UE 120 and network node 110 may communicate wireless signals containing voice traffic, data traffic, and/or control signals over one or more network slices 125a, 125b. When the network node 110 is communicating voice traffic, data traffic, and/or control signals to the UE 120 it may be referred to as a serving network node for the UE 120. The network slice used for the communication may be referred to as a serving network slice. The wireless signals 125 may include both downlink (DL) transmissions, i.e. from the network node 110 to the UE 120, and uplink (UL) transmissions, i.e. from the UE 120 to the network node 110. Each network node 110 may have a single transmitter or multiple transmitters for transmitting signals on the network slices 125a, 125b to the UE 120. In some embodiments, the network node 110 may comprise a multi-input multi-output (MIMO) system. Similarly, each UE 120 may have a single receiver or multiple receivers for receiving signals 125 from the network node 110 or other UEs. Vice versa, the network node 110 may have a single receiver or multiple receivers for receiving signals transmitted from the UE 120 or other network nodes on one or more of the network slices 125a, 125b, and the UE 120 may have a single transmitter or multiple transmitters for transmitting signals to the network node 110 on one or more of the network slices 125a, 125b. When the UE 120 connects to the communications network it may send a network attach request to the network node 110.

FIG. 2 shows an overview of an example of the IMS core network 14. The IMS core network 14 comprises a plurality of IMS nodes 140, which may also be referred to as IMS entities, such as predominantly a Call Session Control Function (CSCF) 141, a Home Subscriber Server (HSS) 145 and a SIP Application Server (AS) 142. The CSCF 141 plays an important role in the IMS core network 14. The CSCF 141 facilitates SIP session setup and teardown. The HSS 145 plays the role of a location server in the IMS core network 14, in addition to acting as an Authentication, Authorization and Accounting (AAA) server. The HSS node 145 also serves as a single point of provisioning for IMS subscribers and their services.

The CSCF 141 comprises three logical entities:
a) Proxy CSCF (P-CSCF) 141a
b) Interrogating CSCF (I-CSCF) 141b, and
c) Serving CSCF (S-CSCF) 141c.

The P-CSCF 141a acts as an entry point into the IMS core network 14. All UEs 120 located in the IMS core network 14 are attached to the P-CSCF 141a. The P-CSCF 141a may be in a home domain or in a visited domain of the UE 120. The P-CSCF 141a is responsible for routing incoming SIP messages to an IMS registrar server and for facilitating policy control over an Rx interface towards a PCRF 131. The P-CSCF 141a is also responsible for setting up IPSec Security associations with the UE 120, thus ensuring secure access to the IMS core network 14.

The I-CSCF 141b acts as an inbound SIP proxy server in the IMS core network 14. During IMS registrations, the I-CSCF 141b queries the HSS 145 to select an appropriate S-CSCF 141c which is able to serve a target UE 120. During IMS sessions, the I-CSCF 141b acts as the entry point to terminating session requests, such as e.g. terminating call procedures. The I-CSCF 141b routes the incoming session requests to the S-CSCF 141c of the target UE 120.

The S-CSCF 141c may act as a registrar server, and in some cases as a redirect server. The S-CSCF 141c is a central point for IMS service control over an ISC reference point. Moreover, the S-CSCF 141c facilitates the routing path for mobile originated or mobile terminated session requests. The S-CSCF 141c may also interact with a Media Resource (MR) Function over an MR interface for playing tones and announcements. The functions of the P-CSCF 141a, the I-CSCF 141b and the S-CSCF 141c may be performed in one node, such as e.g. a collocated I/S-CSCF 141bc, or may be performed in a plurality of nodes.

The AS 142 may host and execute services, and interfaces with the S-CSCF 141c using SIP. Some examples of application servers that is being developed in 3GPP is a Voice call continuity Function, which may also be referred to as a VCC Server, a Multimedia Telephony (MMtel) AS or a Service Centralization and Continuity Application Server (SCC-AS). Depending on the actual service, the AS 142 can operate in SIP proxy mode, SIP UA (user agent) mode or SIP B2BUA mode. The AS 142 may be located in the home network or in an external third-party network. If located in the home network, it can query the HSS with the Diameter Sh or Si interfaces (for a SIP-AS).

The embodiments provided herein introduce and comprise a network slice identifier, which may be used by functions in the IMS core network 14, such as e.g. the IMS node 140, in order to identify the network slice in which a session is established and in which certain actions may trigger different events. For example, the slice identifier may be used in charging events generated by a Charging Triggering Function (CTF) in the IMS core network 14, such as in the IMS node 140. The network slice identifier which may e.g. be in the format of S-NSSAI or a plurality of S-NSSAIs, such as e.g. an NSSAI which comprises a plurality of S-NSSAIs. The network slice identifier may however also have a different format and/or may be based on the S-NSSAI format.

The network slice identifier may thus be used for charging data correlation purposes between a core network 13, such as e.g. an Evolved Packet Core (EPC) or a 5G Core (5GC) and the IMS core network 14. A network function Policy Control Function (PCF) as defined in TS 23.501 may provide this information as part of its service offering consumed by an Application Function (AF) over a Service-based Interface for the Policy Control Function (Npcf) and an N5 reference point located between the PCF and the AF.

Based on the required use case the network slice identifier may be included in SIP signaling. The functional entities that shall use this information may encode it in specific SIP headers according to the purpose of the specific use case. For example, in the case of a charging action, the IMS node 140 may include and/or encode the network slice identifier in a SIP P-Charging-Vector (PCV) header. A Charging Trigger Function (CTF) comprised in the IMS may provide this information to CDFs (Charging Data Function) or OCF (Online Charging Function).

A policy framework may be introduced in the IMS core network 14 which uses the network slice identifier for a variety of diverse purposes, such as e.g. including the network slice identifier in network events sent to offline systems, such as e.g. BSS/OSS, for managing charging as described above being an example, but also for managing e.g. licensing and O&M. The policy framework comprising the network slice identifier as disclosed herein, may also be used to assist in routing decisions.

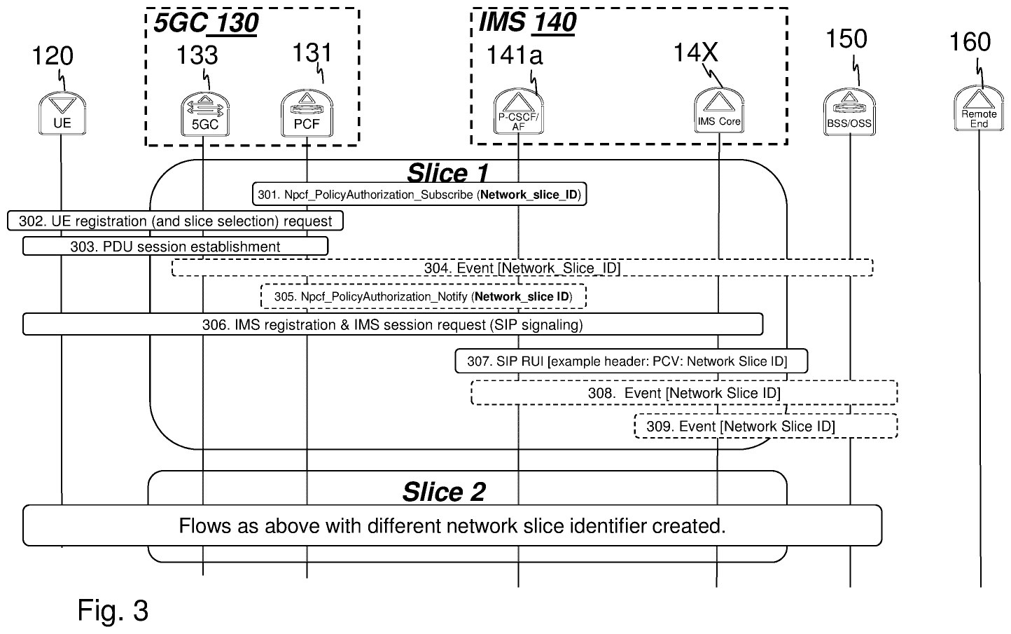

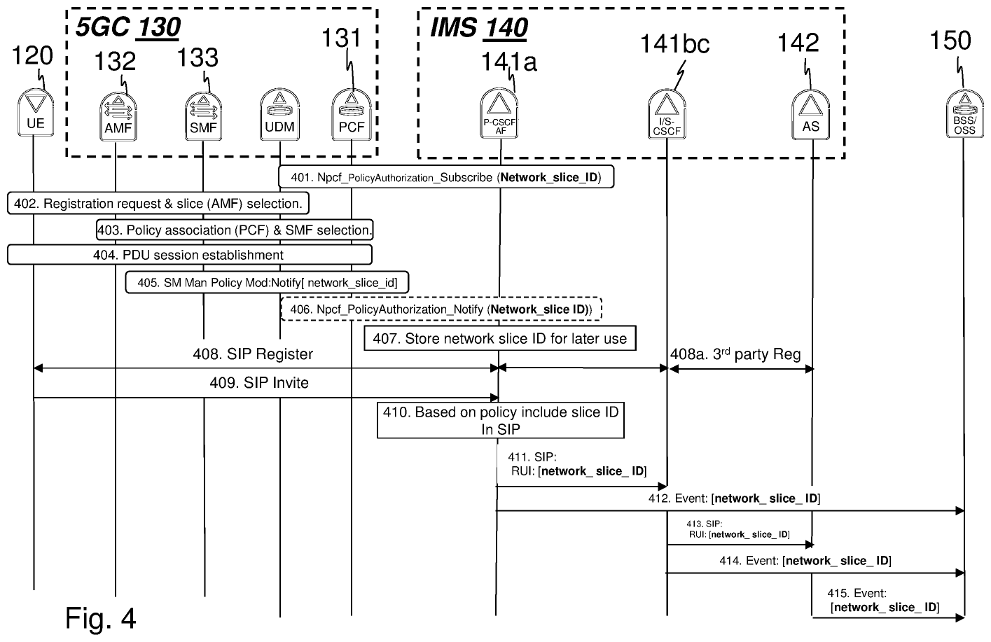

FIGS. 3 and 4 disclose examples of the signaling in the communication network according to embodiments herein. In FIG. 3, which shows an overview of the signaling flow according to the embodiments disclosed herein, two network slices, Slice 1 and Slice 2, may be defined by an operator. An offline management system, such as e.g. a BSS/OSS, which may comprise a charging system, an O&M system, a licensing system etc., is used herein in order to exemplify the use of the slice network identifier. However, the embodiments herein are not limited to O&M, charging and licensing, other use cases are also feasible. In FIG. 3 the flow is indicated only for a first network slice, however the same flow may apply for all slices in the communications network.

Action 301: The IMS node 140 which provides session related information to a PCRF, such as e.g. the P-CSCF/AF 141, may subscribe to a core network node 130 for providing policy rules to a control plane function, such as e.g. the PCF node 131 in FIG. 3. This is in order to obtain newly introduced network slice information. The subscription may be performed using a 5GC Service-based Interface (SBI) operation for the Policy Control Function, such as e.g. an “Npcf_PolicyAuthorization_Subscribe” operation (see 3GPP Technical Specification (TS) 29.514—5G System; Policy Authorization Service; Stage 3)

This action 301 corresponds to action 401 in FIG. 4.

Action 302: A subscriber, such as the UE 120, registers to the communications network, as specified in 3GPP TS 23.502 V15.1.0, and is assigned a Slice (availing of S-NSSAI). In this instance the UE 120 is allocated to a first slice which in FIG. 3 is referred to as “slice 1”.

This action 302 is similar to action 402 in FIG. 4.

Action 303: The UE 120 establishes a Protocol Data Unit (PDU) session. The PDU comprises data and control information which is passed between layers in a protocol stack.

This action 303 is similar to action 404 in FIG. 4.

Action 304: Based on a policy decision the core network node 130, such as the 5GC node, may decide to send a network event, such as e.g. a charging or O&M event, to the managing node 150, such as the BSS/OSS, indicating the network slice ID.

This action 304 is similar to action 405 in FIG. 4.

Action 305: The PCF node 131 notifies the P-CSCF/AF of the network slice ID attribute, the network slice ID may be based on or be similar to the existing NSSAI/S-NSSAI identifiers. The notification of the network slice ID may be performed using a 5GC SBI operation for the Policy Control Function, such as e.g. an “Npcf_PolicyAuthorization_Notify” operation (see e.g. 3GPP TS 29.514).

This action is 305 corresponds to action 406 in FIG. 4.

Action 306: The UE 120 registers with the IMS node 140 and establishes an IMS session.

This action 306 is similar to action 408-409 described with regards to FIG. 4.

Action 307: On session establishment, the IMS node 140, such as the P-CSCF/AF node 141, may decide, based on a policy, if the received attribute, such as the network slice ID, is to be included in a SIP Request Uniform Resource Identifier (SIP Request URI), which may also be abbreviated to SIP RUI, and if so for what purpose. If a policy decision is positive, the network slice ID may be included in a SIP header and forwarded to further nodes 14X in the IMS core network 14, such as e.g. a I-CSCF node, a S-CSCF node, and/or an AS node. The network slice ID may for example be appended to an existing P-charging-vector (PCV) header or may be included in another existing and/or new header. A policy decision framework may also use the network slice ID to assist in routing decisions, e.g. for sending a terminating request to a correct 5GC network slice. This action 307 is similar to action 410, 411 and 413 in FIG. 4.

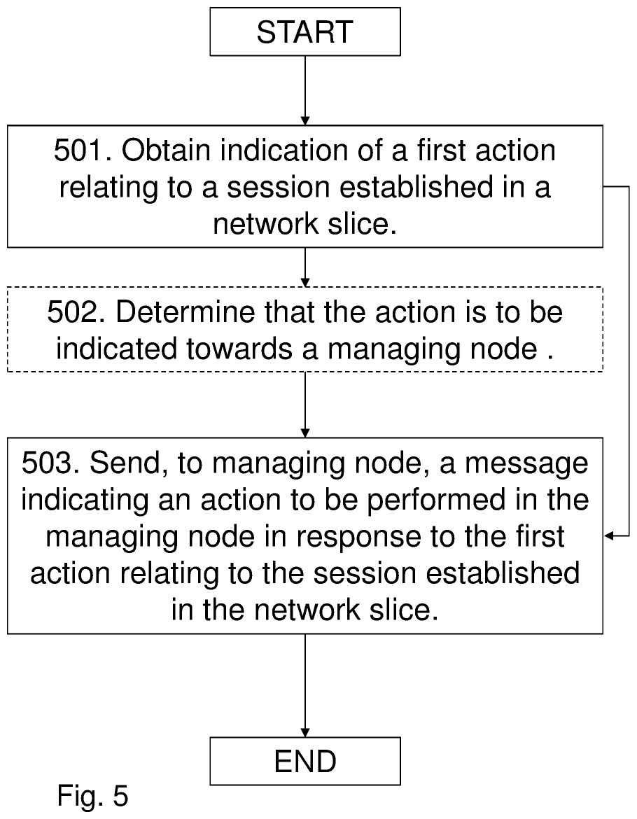

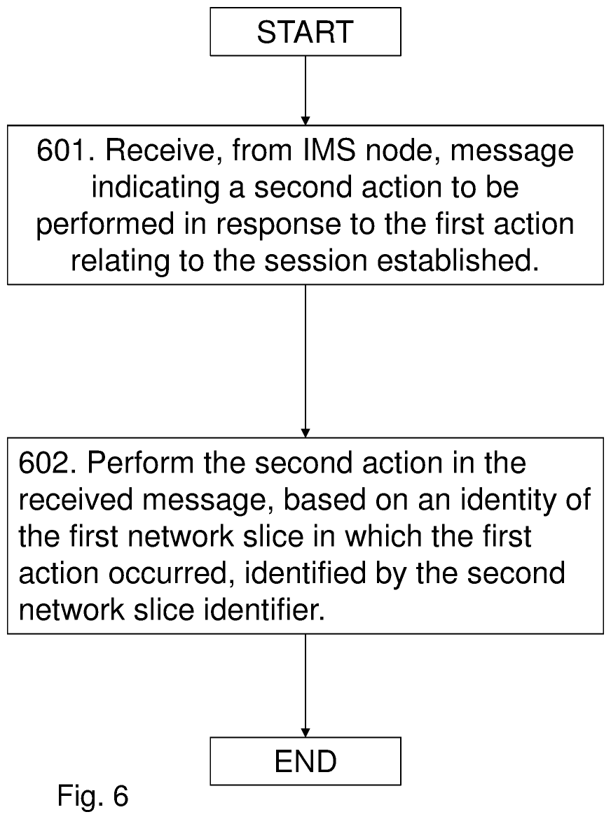

Action 308: On session establishment, the IMS node 140, such as the P-CSCF/AF node 141, may further decide, based on the policy, to send a network event (such as for example a charging, a licensing or an O&M event) to the managing node 150, such as the BSS/OSS, indicating the newly introduced network slice ID. The network slice ID may, as already mentioned, be based on or similar to the existing NSSAI/S-NSSAI identifiers. This action 308 is similar to action 412 in FIG. 4, action 503 described in relation to FIG. 5 below and action 601 described in relation to FIG. 6 below.

Action 309: On session establishment, the IMS node 140, such as the P-CSCF/AF node 141, may further decide if a Virtualized Network Function (VNF), and/or Network Function (NF) and/or a Network Element (NE) in the IMS core network 14 having received the information embedded in the SIP message, may also subsequently issue a network event towards the managing node 150, such as the BSS/OSS. The network event issued towards the managing node 150 may comprise the network slice identifier in order to allow the managing node 150 to determine which network slice has triggered the issuing of the event. The IMS node 140 may decide if the VNF, the NF and/or the NE shall issue the event based on a policy framework. The policy framework may also be used for routing decisions. This action 309 is similar to action 414 and 415 in FIG. 4.

In FIG. 4, which shows a more detailed view of the signaling flow according to the embodiment described in relation to FIG. 3. An offline management system, such as e.g. a BSS/OSS, which may comprise a charging system, an O&M system, a licensing system etc., is used herein in order to exemplify the use of slice network identifier. However, the embodiments herein are not limited to O&M, charging and licensing, other use cases may also be covered by the embodiments herein.

Action 401: The IMS node 140 which provides session related information to a PCRF, which in the embodiment shown in FIG. 4 is the P-CSCF/AF 141, may obtain subscribe to the core network node 130 for providing policy rules to a control plane function, in this case the Policy and Control function (PCF) node 131, in order to obtain the network slice information. The subscription may be performed using a 5GC Service-based Interface (SBI) operation for the Policy Control Function, such as e.g. an “Npcf_PolicyAuthorization_Subscribe” operation (see 3GPP Technical Specification (TS) 29.514—5G System; Policy Authorization Service; Stage 3).

This action 401 corresponds to action 301 in FIG. 3.

Action 402: A subscriber, such as e.g. the UE 120 registers to the communications network, as specified in 3GPP TS 23.502 V15.1.0, and is assigned a Slice, e.g. by means of the S-NSSAI, thereby selecting a relevant Core Access and Mobility Management Function (AMF) node 132 in the core network 130. The UE 120 may also register to a Unified Data Management (UDM) node 134, which manages the UEs subscription profile, such as e.g. the network functions serving the UE 120, and authentication of the UE 120.

This action 402 is similar to action 302 in FIG. 3.

Action 403: The AMF node 132 makes a policy association to the relevant PCF, see 3GPP TS 23.502 V15.1.0 (section 4.2.2.2.2). The AMF node 132 further selects a relevant Service Management Function (SMF) node 133 for the current slice.

Action 404: The UE 120 establishes a Protocol Data Unit (PDU) session, in accordance with 3GPP TS 23.502 V15.1.0 (section 4.3.2.2). The PDU comprises data and control information which is passed between layers in a protocol stack.

This action 404 is similar to action 303 in fig.

Action 405: The SMF performs a Session Management Policy Modification procedure, e.g. by sending an “SM Man Policy Mod:Notify” message, to notify an event in the core network, such as e.g. to the PCF node 131. The “SM Man Policy Mod:Notify” message comprises the network slice ID.

Action 406: The core network node 130 for providing policy rules to a control plane function, which in the embodiment shown in FIG. 4 is the PCF node 131, notifies the IMS node 140 which provides session related information to a Policy and Charging Rule Function (PCRF), such as e.g. the P-CSCF/AF 141, of the network slice ID attribute. The network slice ID may be based on or be similar to the existing NSSAI/S-NSSAI identifiers. The notification of the network slice ID may be performed using a 5GC SBI operation for the Policy Control Function, such as e.g. an “Npcf_PolicyAuthorization_Notify” operation (see e.g. 3GPP TS 29.514).

This action is 405 similar to action 304 in FIG. 3.

Action 407: The IMS node 140 which provides session related information to a PCRF, which in the embodiment shown in FIG. 4 is the P-CSCF/AF 141, stores the network slice ID for later use in the slice policy framework.

Action 408: The UE 120 registers with the IMS by sending a SIP register message to the IMS node 140, such as e.g. the P-CSCF/AF node 141a, the I-CSCF node 141b, the S-CSCF node 141c and/or a combination thereof, in accordance with 3GPP TS 10 24.229. This action 408 is similar to action 306 described with regards to FIG. 3.

Action 408a: The UE 120 may perform a 3^{rd} party registration by sending a SIP register message the AS 142 in the IMS, in order to let the AS know that the UE is now connected and ready to communicate. The 3rd party registration may e.g. be forwarded to the AS 142 from the S-CSCF 141c in the IMS. This action 408a is similar to action 306 described with regards to FIG. 3.

Action 409: The UE 120 establishes an IMS session by sending an invite, such as a SIP Invite, to the IMS node 140, which in the embodiment shown in FIG. 4 is the P-CSCF node 141, in accordance with 3GPP TS 24.229. This action 409 is similar to action 306 described with regards to FIG. 3.

Action 410: On session establishment, the IMS node 140, which in the embodiment shown in FIG. 4 is the P-CSCF/AF node 141, may decide, based on a policy framework, if the attribute received in action 406, such as the network slice ID, is to be included in the SIP Request Uniform Resource Identifier (SIP Request URI) and if so for what purpose. If a policy decision is positive, the network slice ID may be included in the SIP header of a SIP message. The network slice ID may for example be appended to an existing P-charging-vector header or may be included in another existing and/or new header. A P-CSCF/AF policy decision framework may also use the network slice ID to assist in routing decisions, e.g. for sending a terminating request to a correct 5GC network slice. This action 410 corresponds to action 307 in FIG. 3.

Action 411: The P-CSCF node 141a in the IMS may forward the SIP RUI comprising the network slice ID to the I-CSCF node 141b, the S-CSCF node 141c or a combined I/S-CSCF node 141bc.

Action 412: On session establishment, the IMS node 140, which in the embodiment shown in FIG. 4 is the P-CSCF/AF node 141, may further decide, based on the policy framework, to send a network event (such as for example a charging, a licensing or an O&M event) to the managing node 150, such as the BSS/OSS, indicating the newly introduced network slice ID. The network slice ID may, as already mentioned, be based on or similar to the existing NSSAI/S-NSSAI identifiers. This action 412 is similar to the action 308 in FIG. 3, action 503 described in relation to FIG. 5 below and action 601 described in relation to FIG. 6 below.

Action 413: The CSCF node, such as the I/S-CSCF node 141bc as shown in FIG. 4, may based on an initial filter criteria (Ifc), forward the SIP RUI comprising the network slice ID to an Application Server (AS) node of the IMS. The AS node may for example be a Telephony Application Server (TAS) which may be used within the IMS to facilitate Voice over LTE (VoLTE) call establishment procedures, as well as support supplementary services such as Calling Party ID, Call Transfer and Call Barring.

Action 414: The CSCF node, which in the embodiment shown in FIG. 4 is the I/S-CSCF node 141bc, may further based on a “network slice” policy framework, after having received the information embedded in the SIP RUI forwarded in Action 411, subsequently issue a network event (policy driven) towards the managing node 150, such as the BSS/OSS node shown in FIG. 4, which event comprises the network slice identifier. The policy framework can also be used for routing decisions. This action 414 is similar to the action 503 described in relation to FIG. 5 below and action 601 described in relation to FIG. 6 below.

Action 415: The AS node 142, such as e.g. the TAS, may further based on the “network slice” policy framework, after having received the information embedded in the SIP RUI forwarded in Action 411, subsequently issue a network event (policy driven) towards the managing node 150, such as the BSS/OSS node shown in FIG. 4, which event comprises the network slice identifier. The policy framework can also be used for routing decisions. This action 415 is similar to the action 503 described in relation to FIG. 5 below and action 601 described in relation to FIG. 6 below.

The method actions performed by the IMS node 140, for enabling management of events occurring in a network slice of a communication network 100 according to embodiments herein will now be described with reference to a flowchart depicted in FIG. 5. Actions performed in some embodiments only are marked with dashed boxes. The communication network 100 comprises partitioned sets of functionalities. A first set of functionalities belongs to the first network slice in the communication network 100. Each set of functionalities belongs to a network slice. The first set of functionalities is at least partly separated from another set of functionalities out of a total set of functionalities in the communications network 100.

In other words, each network slice in the communications network 100 comprises an independent set of functionalities, such as e.g. logical network functions, which support requirements of a particular use case.

Each network slice may be optimized to provide resources and network topology for a specific service and/or traffic that will use the slice. Functions, such as speed, capacity, connectivity and coverage may be allocated to meet specific demands of each use case. However, functional components may also be shared across different network slices.

By having partitioned sets of functionalities, each network slice may be completely isolated so that the network slices do not interfere with traffic in another slice.

Each network slice may be configured with its own network architecture, engineering mechanism and network provisioning. The network slice will typically contain management capabilities, which may be controlled by a network operator or a customer, depending on the use case, and may be independently managed and orchestrated.

Action 501: The IMS node 140 obtains from the core network node 131 responsible for policy control, an indication of a first action. The first action relates to a session established in the network slice. The indication of the first action comprises a first network slice identifier identifying the network slice. The indication is obtained to in order to identify the network slice in which the first action is performed and may be used to route traffic from and/or to the network slice and or to perform specific functionality related to the network slice.

The first action relating to the session may be e.g. a session establishment and/or a session modification and/or a bearer establishments and/or bearer modification and/or an IMS registration occurring in the network slice. The first indication may comprise the first network slice identifier identifying the network slice in which the first action occurs.

The first action relating to the session may trigger a charging event, an Operation and Maintenance, O&M, event, and/or a licensing event.

The session may be a data transmission or a voice session established on the network slice. The session may be established between the UE 120 and the packet core node 130 via the RAN node 110.

The first network slice identifier may be a Single Network Slice Selection Assistance Information (S-NSSAI) or a Network Slice Selection Assistance Information (NSSAI).

The IMS node 140 may be a CSCF node 141, such as a P-CSCF 141a, an I-CSCF 141b, an S-CSCF 141c or any combination thereof.

In some examples the IMS node 140 may be an Application Server (AS) node 142.

The core network node 130 responsible for policy control may e.g. be an Evolved Packet Core (EPC) node or a 5G Core (5GC) node.

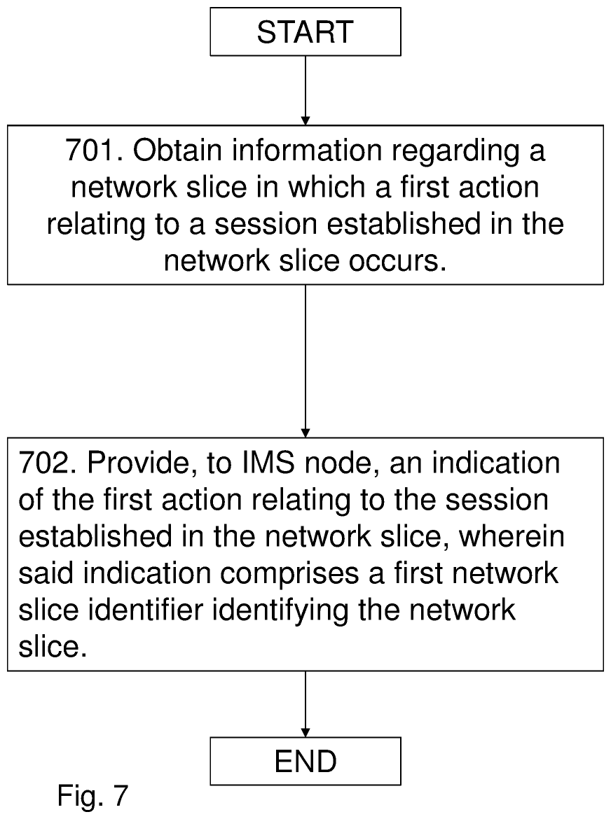

This action 501 is similar to the action 406 and action 409 described above in relation to FIG. 4, action 304 described above in relation to FIG. 3 and action 702 described below in relation to FIG. 7.

Action 502: The IMS node 140 may determine that a second action is to be indicated towards the managing node 150, based on the indication of the first action relating to a session occurring in the network slice. This may be determined since some first actions, such as e.g. a data transmission or a voice session established on the network slice, may trigger events, such as e.g. a charging event, an Operation and Maintenance, O&M, event, and/or a licensing event towards the managing node 150.

This action 502 is similar to the action 410 described above in relation to FIG. 4 and action 307 in FIG. 3.

Action 503: The IMS node 140 sends a message to the managing node 150. The message indicates a second action to be performed in the managing node 150 in response to the first action relating to the session established in the network slice. In response shall herein be interpreted as the first action triggering the second action to be performed in the managing node 150. The message comprises a second network slice identifier identifying the first network slice in which the first action occurred. The second network slice identifier may also be forwarded within the IMS node 140, when the IMS node 140 comprises further nodes, such as e.g. the CSCF node 141, such as the P-CSCF node 141a, the I-CSCF node 141b, the S-CSCF node 141c, the AS node 142 or any combination thereof, by means of a message, such as e.g. a SIP message.

The IMS node 140 may send the message based on an IMS registration or a session establishment as a result of the session establishment in the core network 130, such as e.g. the EPC or 5GC.

The managing node 150 may e.g. be a Business Support System/Operation Support System (BSS/OSS) node.

The message sent to the managing node 150 may be a management protocol message, such as diameter protocol message or a Simple Network Management Protocol (SNMP) message.

The second action may be an O&M, a charging related or a licensing related action, such as e.g. a generation of billing correlation, a generation of O&M fault management information, an initiation of a repair event, a correlation of license keys and/or a generation of license usage information.

This enables the managing node 150, such as the BSS/OSS, to correlate the various events from different network nodes, VNFs, NFs and/or NEs based on the slice identifier.

This action 503 is similar to the action 308 described above in relation to FIG. 3, action 412, 414 and 415 described above in relation to FIG. 4, and action 601 described below in relation to FIG. 6.

FIG. 6 illustrates the method actions performed by the managing node 150, for managing events occurring in a network slice of the communication network 100. The communication network 100 comprises partitioned sets of functionalities wherein each set of functionalities belongs to a dedicated network slice, and wherein a set of functionalities is separated from other sets of functionalities out of a total set of functionalities in the communication network 100.

Action 601: The managing node 150 receives a message from the IMS node 140. The message indicates a second action to be performed in response to a first action relating to the session established in the network slice. In response shall herein be interpreted as the first action triggering the second action to be performed in the managing node 150. The message comprises a second network slice identifier identifying the first network slice in which the first action occurred.

The first action relating to the session may be e.g. a session establishment and/or a session modification and/or a bearer establishment and/or bearer modification and/or an IMS registration occurring in the network slice, and the first indication may comprise the first network slice identifier identifying the network slice in which the first action occurs.

The first action may trigger a charging event, an Operation and Maintenance, O&M, event, and/or a licensing event.

The first session may be a data transmission or a voice session on the first network slice.

The first network slice identifier may be the S-NSSAI or the NSSAI or any other identifier which may indicate the network slice.

The IMS node 140 may be a CSCF node 141, such as a P-CSCF 141a, an I-CSCF 141b an S-CSCF 141c and/or any combination thereof. In some examples herein, the IMS node 140 may also be an AS node 142.

The managing node 150 may e.g. be a Business Support System/Operation Support System (BSS/OSS) node.

The message sent to the managing node 150 may be a management protocol message, such as diameter protocol message or a Simple Network Management Protocol (SNMP) message.

The second action may be a generation of billing correlation, generation of O&M fault management information, initiation of a repair event, correlation of license keys, and/or a generation of license usage information.

This action 601 is similar to the action 308 described above in relation to FIG. 3, action 412, 414 and 415 described above in relation to FIG. 4, and action 503 described below in relation to FIG. 5.

Action 602: The managing node 150 performs the second action in the received message. The second action is performed based on the identity of the first network slice in which the first action occurred, which is identified by the second network slice identifier in the message received from the IMS node 140. The second network slice identifier may be the same as the first network slice identifier, and may e.g. be a S-NSSAI or the NSSAI identifier. The second network slice identifier may however also be different than the first slice identifier and may partially comprise the first slice identifier.

FIG. 7 illustrates the method actions performed by the core network node 130 responsible for policy control, for managing events occurring in a network slice of the communication network 100. The communication network 100 comprises partitioned sets of functionalities wherein each set of functionalities belongs to a network slice, and wherein a set of functionalities is separated from other sets of functionalities out of a total set of functionalities in the communication network 100. The core network node 130 responsible for policy control, may e.g. be the PCF node 131 or a PCRF node.

Action 701: The core network node 130 responsible for policy control may obtain information regarding a network slice in which a first action relating to a session established in the network slice occurs. The information regarding the network slice in which the first action occurs may comprise a first network slice identifier which allows the core network node 130 to identify the network slice in which the first action occurs.

Action 702: The core network node 130 responsible for policy control provides an indication of the first action relating to the session established in the network slice to the IMS node 140. The indication of the first action relating to the session established in the network slice comprises a first network slice identifier identifying the network slice. The core network node 130 responsible for policy control may provide the indication of the first action by sending the indication of the first action to the IMS node 140. The indication of the first action may e.g. be sent to the IMS node 140 in a SIP message. This action 701 is similar to the action 308 described above in relation to FIG. 3, action 412, 414 and 415 described above in relation to FIG. 4, and action 601 described below in relation to FIG. 6.

The first action relating to the session may be e.g. a session management establishment and/or a session management modification occurring in the network slice, and the first indication may comprise the first network slice identifier identifying the network slice in which the first action occurs.

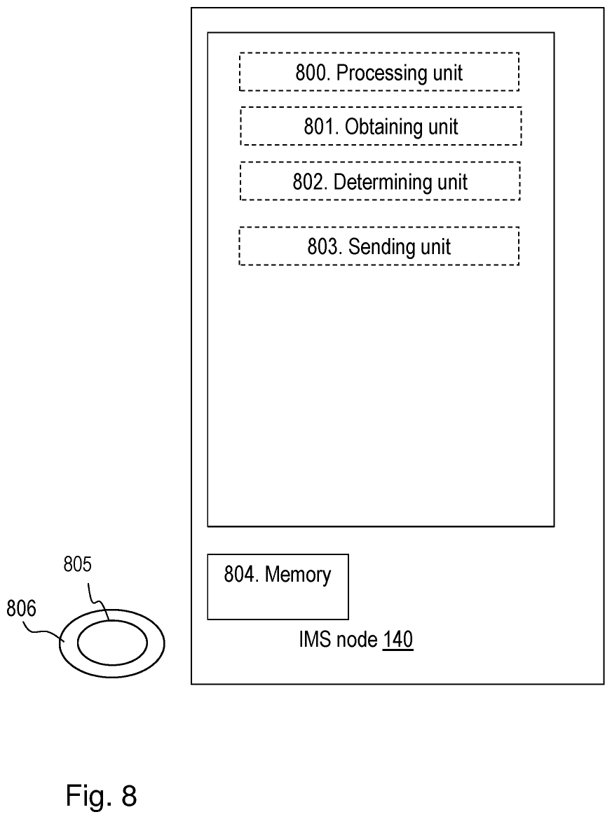

FIG. 8 is a block diagram depicting the IMS node 140, for enabling management of events occurring in a network slice of the communication network 100. The communication network 100 comprises partitioned sets of functionalities wherein each set of functionalities belongs to a dedicated network slice, and wherein a set of functionalities is separated from other sets of functionalities out of a total set of functionalities in the communication network 100. The IMS node 140 may comprise a processing unit 800, such as e.g. one or more processors, an obtaining unit 801, a determining unit 802 and/or a sending unit 803 as exemplifying hardware units configured to perform the method as described herein.

The IMS node 140 is configured to, e.g. by means of the processing unit 800 and/or the obtaining unit 801 being configured to, obtain an indication of a first action relating to a session established in the network slice, from a core network node 130 responsible for policy control, wherein the first indication comprises a first network slice identifier identifying the network slice.

The IMS node 140 is further configured to, e.g. by means of the processing unit 800 and/or the sending unit 803 being configured to, send a message to the managing node 150 indicating a second action to be performed in the managing node 150 in response to the first action relating to the session established in the network slice. Wherein the message comprises a second network slice identifier identifying the first network slice in which the first action occurred.

The IMS node 140 may further be configured to, e.g. by means of the processing unit 800 and/or the sending unit 803 being configured to, send the message based on an IMS registration or a session establishment as a result of the session establishment in the core network 130, such as e.g. the EPC or 5GC.

The IMS node 140 may further be configured to, e.g. by means of the processing unit 800 and/or the determining unit 803 being configured to, determine, based on the indication of the first action relating to a session occurring in the network slice, that the action is to be indicated towards the managing node 150.

The first action relating to the session which the IMS node 140 is configured to, e.g. by means of the processing unit 800 and/or the determining unit 803 being configured to, obtain an indication of, may be a trigger for a charging event, an Operation and Maintenance, O&M, event, and/or a licensing event.

The session established in the network slice may be a data transmission or a voice session on the network slice.

The first network slice identifier which the IMS node 140 is configured to, e.g. by means of the processing unit 800 and/or the obtaining unit 803 being configured to, obtain or the second network slice identifier which the IMS node 140 is configured to, e.g. by means of the processing unit 800 and/or the sending unit 802 being configured to, send, may be an S-NSSAI or a NSSAI.

The IMS node 140 may be a CSCF node, such as a P-CSCF, an I-CSCF an S-CSCF or any combination thereof, or an AS node.

The IMS node 140 may be configured to, e.g. by means of the processing unit 800 and/or the sending unit 803 being configured to, send the message to a BSS/OSS node.

The IMS node 140 may be configured to, e.g. by means of the processing unit 800 and/or the sending unit 803 being configured to, send the message as a management protocol message, such as e.g. a diameter protocol message or an SNMP message.

The IMS node 140 may be configured to, e.g. by means of the processing unit 800 and/or the sending unit 803 being configured to, indicating a generation of billing correlation, generation of O&M fault management information, initiation of a repair event, correlation of license keys and/or a generation of license usage information, as the second action to be performed in the managing node 150 in response to the first action relating to the session established in the network slice.

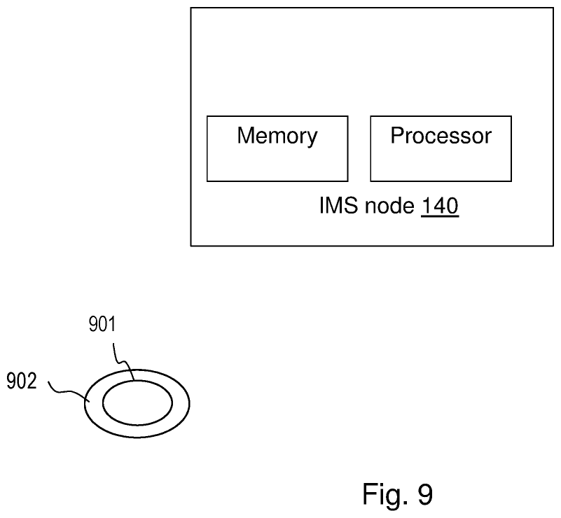

The embodiments herein may be implemented through a respective processor or one or more processors of a processing circuitry in the IMS node 140 as depicted in FIG. 9, which processing circuitry is configured to perform the method actions according to FIG. 5 and the embodiments described above for the IMS node 140.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the IMS node 140. One such carrier may be in the form of a CD ROM disc. It is however feasible with other data carriers such as e.g. a memory stick. The computer program code may furthermore be provided as pure program code on a server and downloaded to the IMS node 140.

The IMS node 140 may further comprise a memory. The memory may comprise one or more memory units to be used to store data on, such as software, patches, system information, configurations, diagnostic data, performance data and/or applications to perform the methods disclosed herein when being executed, and similar.

The method according to the embodiments described herein for the IMS node 140 may be implemented by means of e.g. a computer program product 805, 901 or a computer program, comprising instructions, i.e., software code portions, which, when executed on at least one processor, cause at least one processor to carry out the actions described herein, as performed by the IMS node 140. The computer program product 805, 901 may be stored on a computer-readable storage medium 806, 902, e.g. a disc or similar. The computer-readable storage medium 806, 902, having stored thereon the computer program, may comprise instructions which, when executed on at least one processor, cause the at least one processor to carry out the actions described herein, as performed by the IMS node 140. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

The IMS node 140, described in the embodiments herein may also be implemented in a cloud. Although the method actions performed by the IMS node 140 herein are discussed in the context of core network node, the method may also be performed by a distributed node comprised in a first cloud, such as e.g. a server and/or a datacenter. The method actions may e.g. be performed by a logical function, which may be a centralized service hosted on the core network node or the distributed node.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

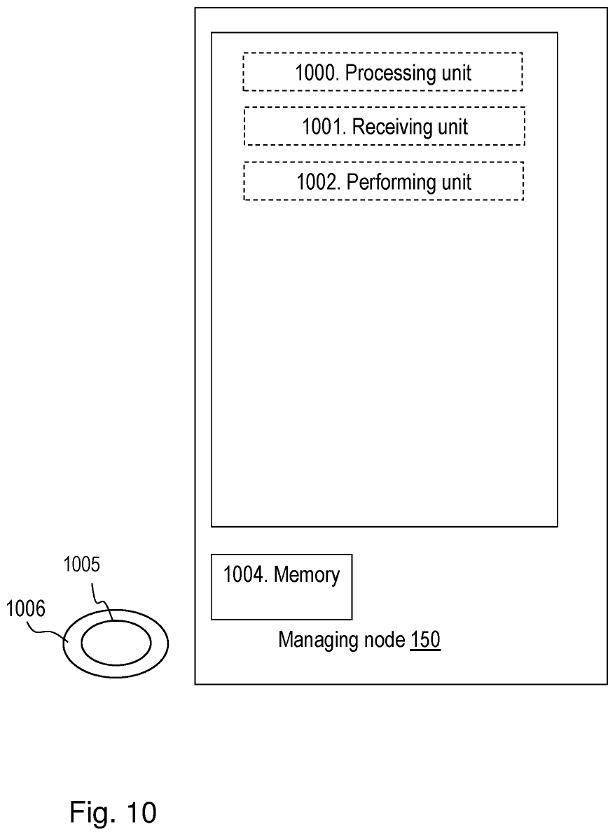

FIG. 10 is a block diagram depicting the managing node 150, for enabling management of events occurring in a network slice of a communication network 100. The communication network 100 comprises partitioned sets of functionalities wherein each set of functionalities belongs to a dedicated network slice, and wherein a set of functionalities is separated from other sets of functionalities out of a total set of functionalities in the communication network 100. The managing node 150 may comprise a processing unit 1000, such as e.g. one or more processors, a receiving unit 1001 and/or a performing unit 1002 as exemplifying hardware units configured to perform the method as described herein.

The managing node 150 is configured to, e.g. by means of the processing unit 1000 and/or the receiving unit 1001 being configured to, receive a message indicating a second action to be performed in response to a first action relating to the session established in the network slice from the IMS node 140. The message comprises a second network slice identifier identifying the first network slice in which the first action occurred.

The managing node 150 is further configured to, e.g. by means of the processing unit 1000 and/or the performing unit 1002 being configured to, perform the second action in the received message, wherein the second action is performed based on an identity of the first network slice in which the first action occurred.

The first action relating to the session which the managing node 150 is configured to, e.g. by means of the processing unit 1000 and/or the receiving unit 1002 being configured to, receive a message indicating the second action to be performed in response to, may trigger a charging event, an Operation and Maintenance, O&M, event, and/or a licensing event.

The second network slice identifier which the managing node 150 is configured to, e.g. by means of the processing unit 1000 and/or the receiving unit 1002 being configured to, receive from the IMS node 140 may be an S-NSSAI or a NSSAI.

The managing node 150 may be configured to, e.g. by means of the processing unit 1000 and/or the receiving unit 1001 being configured to, receive the message indicating a second action to be performed from a CSCF node, such as a P-CSCF, an I-CSCF an S-CSCF or any combination thereof, or an AS node.

The managing node 150 may e.g. be a BSS/OSS node.

The managing node 150 may be configured to, e.g. by means of the processing unit 1000 and/or the receiving unit 1001 being configured to, receive the message as a management protocol message, such as e.g. a diameter protocol message or an SNMP message, from the IMS node 140.

The managing node 150 may be configured to, e.g. by means of the processing unit 1000 and/or the receiving unit 1003 being configured to, perform a generation of billing correlation, a generation of O&M fault management information, an initiation of a repair event, a correlation of license keys and/or a generation of license usage information as the second action in response to the first action relating to the session established in the network slice.

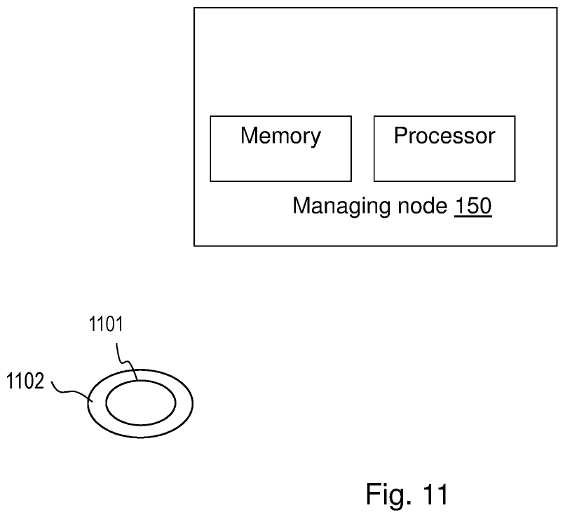

The embodiments herein may be implemented through a respective processor or one or more processors of a processing circuitry in the managing node 150 as depicted in FIG. 11, which processing circuitry is configured to perform the method actions according to FIG. 6 and the embodiments described above for the managing node 150.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the managing node 150. One such carrier may be in the form of a CD ROM disc. It is however feasible with other data carriers such as e.g. a memory stick. The computer program code may furthermore be provided as pure program code on a server and downloaded to the managing node 150.

The managing node 150 may further comprise a memory. The memory may comprise one or more memory units to be used to store data on, such as software, patches, system information, configurations, diagnostic data, performance data and/or applications to perform the methods disclosed herein when being executed, and similar.

The method according to the embodiments described herein for the managing node 150 may be implemented by means of e.g. a computer program product 1005, 1101 or a computer program, comprising instructions, i.e., software code portions, which, when executed on at least one processor, cause at least one processor to carry out the actions described herein, as performed by the managing node 150. The computer program product 1005, 1101 may be stored on a computer-readable storage medium 1006, 1102, e.g. a disc or similar. The computer-readable storage medium 1006, 1102, having stored thereon the computer program, may comprise instructions which, when executed on at least one processor, cause the at least one processor to carry out the actions described herein, as performed by the managing node 150. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node.

Alternatively, several of the functional elements of the processing means discussed may be provided through the use of dedicated hardware, while others are provided with hardware for executing software, in association with the appropriate software or firmware.

Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

The managing node 150, described in the embodiments herein may also be implemented in a cloud. Although the method actions performed by the managing node 150 herein are discussed in the context of core network node, the method may also be performed by a distributed node comprised in a first cloud, such as e.g. a server and/or a datacenter. The method actions may e.g. be performed by a logical function, which may be a centralized service hosted on the core network node or the distributed node.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

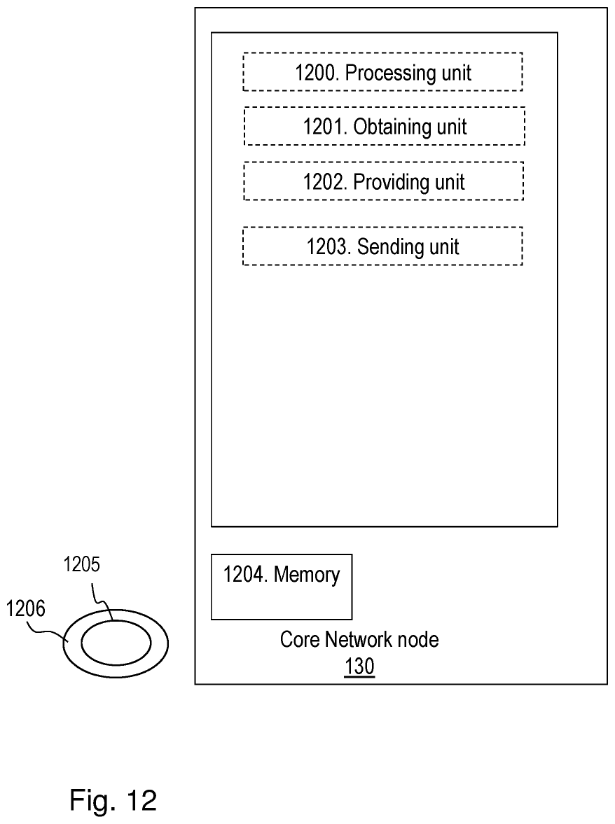

FIG. 12 is a block diagram depicting the core network node 130 responsible for policy control, for managing events occurring in a network slice of a communication network. The communication network 100 comprises partitioned sets of functionalities wherein each set of functionalities belongs to a dedicated network slice, and wherein a set of functionalities is separated from other sets of functionalities out of a total set of functionalities in the communication network 100. The core network node 130 responsible for policy control may comprise a processing unit 1200, such as e.g. one or more processors, an obtaining unit 1201, a providing unit 1202 and/or a sending unit 1203 as exemplifying hardware units configured to perform the method as described herein.

The core network node 130 responsible for policy control may be configured to, e.g. by means of the processing unit 1200 and/or the obtaining unit 1201 being configured to, obtain information regarding a network slice in which a first action relating to a session established in the network slice occurs.

The core network node 130 responsible for policy control is configured to, e.g. by means of the processing unit 1200 and/or the providing unit 1202 being configured to, provide an indication of the first action relating to the session established in the network slice to the IMS node 140. The indication comprises the first network slice identifier identifying the network slice.

The core network node 130 responsible for policy control may further be configured to, e.g. by means of the processing unit 1200 and/or the providing unit 1202 and/or the sending unit 1203 being configured to, provide the indication of the first action by sending the indication of the first action relating to the session established in the network slice to the IMS node 140.

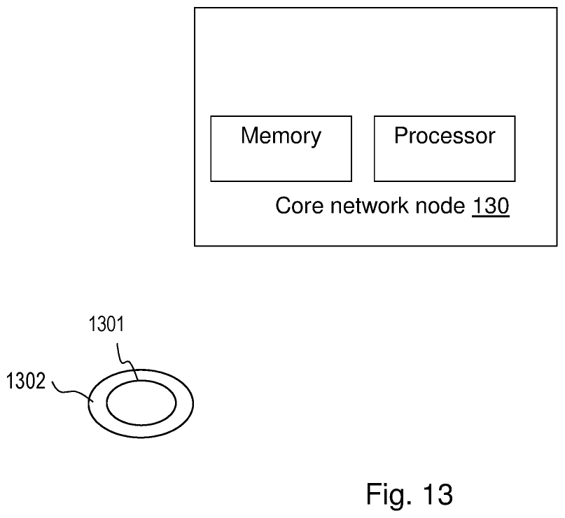

The embodiments herein may be implemented through a respective processor or one or more processors of a processing circuitry in the core network node 130 as depicted in FIG. 13, which processing circuitry is configured to perform the method actions according to FIG. 7 and the embodiments described above for the core network node 130.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the core network node 130. One such carrier may be in the form of a CD ROM disc. It is however feasible with other data carriers such as e.g. a memory stick. The computer program code may furthermore be provided as pure program code on a server and downloaded to the core network node 130.

The core network node 130 may further comprise a memory. The memory may comprise one or more memory units to be used to store data on, such as software, patches, system information, configurations, diagnostic data, performance data and/or applications to perform the methods disclosed herein when being executed, and similar.

The method according to the embodiments described herein for the core network node 130 may be implemented by means of e.g. a computer program product 1205, 1301 or a computer program, comprising instructions, i.e., software code portions, which, when executed on at least one processor, cause at least one processor to carry out the actions described herein, as performed by the core network node 130. The computer program product 1205, 1301 may be stored on a computer-readable storage medium 1206, 1302, e.g. a disc or similar. The computer-readable storage medium 1006, 1102, having stored thereon the computer program, may comprise instructions which, when executed on at least one processor, cause the at least one processor to carry out the actions described herein, as performed by the core network node 130. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

The core network node 130, described in the embodiments herein may also be implemented in a cloud. Although the method actions performed by the core network node 130 herein are discussed in the context of core network node, the method may also be performed by a distributed node comprised in a first cloud, such as e.g. a server and/or a datacenter. The method actions may e.g. be performed by a logical function, which may be a centralized service hosted on the core network node or the distributed node.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

When using the word “comprise” or “comprising” it shall be interpreted as non-limiting, i.e. meaning “consist at least of”. When using the word “set” herein, it shall be interpreted as meaning “one or more”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by an IP Multimedia Core Network Subsystem (IMS) node, for managing actions occurring in a network slice of a communication network, which communication network comprises partitioned sets of functionalities wherein each set of functionalities belongs to a dedicated network slice, and wherein a set of functionalities is separated from other sets of functionalities out of a total set of functionalities in the communication network, the method comprising:
obtaining, from a core network node responsible for policy control, an indication of a first action relating to a session established in the network slice, wherein said first indication comprises a first network slice identifier identifying the network slice,
sending, to a managing node, a message indicating a second action to be performed in the managing node in response to the first action relating to the session established in the network slice, and wherein the message comprises a second network slice identifier identifying the first network slice in which the first action occurred.

2. The method according to claim 1, wherein the method further comprises:
determining, based on the indication of the first action relating to a session occurring in the network slice, that the action is to be indicated towards the managing node.

3. The method according to claim 1, wherein the first action relating to the session triggers one or more of a charging event, an Operation and Maintenance, (O&M) event, and a licensing event.

4-8. (canceled)

9. The method according to claim 1, wherein the second action is one or more of a generation of billing correlation, generation of O&M fault management information, initiation of a repair event, correlation of license keys and a generation of license usage information.

10. A method performed by a managing node, for managing actions occurring in a network slice of a communication network, which communication network comprises partitioned sets of functionalities wherein each set of functionalities belongs to a dedicated network slice, and wherein a set of functionalities is separated from other sets of functionalities out of a total set of functionalities in the communication network, the method comprising:
receiving, from an IP Multimedia Core Network Subsystem (IMS) node, a message indicating a second action to be performed in response to a first action relating to a session established in a first network slice, and wherein the message comprises a second network slice identifier identifying the first network slice in which the first action occurred; and
performing the second action in the received message, wherein the second action is performed based on an identity of the first network slice in which the first action occurred.

11. The method according to claim 10, wherein the first action triggers one or more of a charging event, an Operation and Maintenance (O&M) event, and a licensing event.

12. The method according to claim 10, wherein the session is a data transmission or a voice session on the first network slice.

13-15. (canceled)

16. The method according to claim 10, wherein the second action performed by the managing node is one or more of a generation of billing correlation, O&M fault management information, initiating a repair event, correlation of license keys and a generation of license usage information.

17. A method performed by a core network node responsible for policy control, for managing actions occurring in a network slice of a communication network, which communication network comprises partitioned sets of functionalities wherein each set of functionalities belongs to a network slice, and wherein a set of functionalities is separated from other sets of functionalities out of a total set of functionalities in the communication network, the method comprising:
providing to an IP Multimedia Core Network Subsystem (IMS) node, an indication of a first action relating to a session established in the network slice, wherein said indication comprises a first network slice identifier identifying the network slice.

18. The method according to claim 17, wherein the method further comprises:
obtaining, information regarding a network slice in which a first action relating to a session established in the network slice occurs.

19. The method according to claim 17, wherein the providing comprises sending the indication of the first action to the IMS node.

20. An IP Multimedia Core Network Subsystem (IMS) node, for managing actions occurring in a network slice of a communication network, which communication network comprises partitioned sets of functionalities wherein each set of functionalities belongs to a dedicated network slice, and wherein a set of functionalities is separated from other sets of functionalities out of a total set of functionalities in the communication network, the IMS node comprising:
a processor; and
a memory containing instructions which, when executed by the processor, cause the IMS node to:
obtain, from a core network node responsible for policy control, an indication of a first action relating to a session established in the network slice, wherein said first indication comprises a first network slice identifier identifying the network slice,
send, to a managing node, a message indicating a second action to be performed in the managing node in response to the first action relating to the session established in the network slice, and wherein the message comprises a second network slice identifier identifying the first network slice in which the first action occurred.

21. The IMS node according to claim 20, wherein the IMS node further is to:
determine, based on the indication of the first action relating to a session occurring in the network slice, that the action is to be indicated towards the managing node.

22. The IMS node according to claim 20, wherein the first action relating to the session triggers one or more of a charging event, an Operation and Maintenance, (O&M) event, and a licensing event.

23. The IMS node according to claim 20, wherein the session is a data transmission or a voice session on the network slice.

24. The IMS node according to claim 20, wherein the network slice identifier is a Single Network Slice Selection Assistance Information (S-NSSAI) or a Network Slice Selection Assistance Information (NSSAI).

25. The IMS node according to claim 20, wherein the IMS node is a Call Session Control Function (CSCF) node.

26. The IMS node according to claim 20, wherein the IMS node is an Application Server (AS) node.

27. The IMS node according to claim 20, wherein the message sent to the managing node is a management protocol message.

28. The IMS node according to claim 20, wherein the second action is one or more of a generation of billing correlation, generation of O&M fault management information, initiation of a repair event, correlation of license keys and/or a generation of license usage information.

29-40. (canceled)
